(19) United States
(12) Patent Application Publication
(10) Pub. No.: US 2026/0012847 A1
(43) Pub. Date: Jan. 8, 2026

(54) TECHNOLOGIES FOR MEDIA ACCESS CONTROL CONGESTION SIGNALING

(71) Applicant: Apple Inc., Cupertino, CA (US)

(72) Inventors: Ralf Rossbach, Munich (DE); Fangli Xu, Beijing (CN); Bobby Jose, San Diego, CA (US); Vijay Venkataraman, San Jose, CA (US); Srinivas Reddy Mudireddy, San Diego, CA (US); Haijing Hu, Los Gatos, CA (US); Ping-Heng Kuo, London (GB)

(73) Assignee: Apple Inc., Cupertino, CA (US)

(21) Appl. No.: 19/111,762

(22) PCT Filed: Sep. 29, 2022
(86) PCT No.: PCT/CN2022/122877

§ 371 Date: Mar. 13, 2025

(30) Foreign Application Priority Data
Sep. 23, 2022 (WO) PCT/CN2022/120928

(51) Int. Cl. H04W 28/02

(52) U.S. Cl. CPC H04W 28/0278; H04W 28/0268

(57) ABSTRACT

The present application relates to devices and components including apparatus, systems, and methods for media access control congestion signaling in wireless networks.

### TECHNICAL FIELD

This application relates generally to communication networks and, in particular, to technologies for media access control congestion signaling in such networks.

### BACKGROUND

Low latency low loss scale throughput (L4S) is a technology based on an Internet Engineering Task Force (IETF) standardization. L4S provides high throughput and low latency for Internet protocol (IP) traffic that may result in improved, fast-radio adaption management and reduce network congestion, queuing, and packet loss.

### BRIEF DESCRIPTION OF THE DRAWINGS

FIG. 1 illustrates a network environment in accordance with some embodiments.

FIG. 2 illustrates the network environment with integrated access and backhaul concepts in accordance with some embodiments.

FIG. 3 illustrates a device of the network environment in accordance with some embodiments.

FIG. 4 illustrates media access control (MAC) protocol data units (PDUs) in accordance with some embodiments.

FIG. 5 illustrates MAC subheaders in accordance with some embodiments.

FIG. 6 illustrates MAC control elements in accordance with some embodiments.

FIG. 7 illustrates MAC PDUs in accordance with some embodiments.

FIG. 8 illustrates MAC subheaders in accordance with some embodiments.

FIG. 9 illustrates an operational flow/algorithmic structure in accordance with some embodiments.

FIG. 10 illustrates another operational flow/algorithmic structure in accordance with some embodiments.

FIG. 11 illustrates another operational flow/algorithmic structure in accordance with some embodiments.

FIG. 12 illustrates an user equipment in accordance with some embodiments.

FIG. 13 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and/or techniques in order to provide a thorough understanding of the various aspects of some embodiments. However, it will be apparent to those skilled in the art having the benefit of the present disclosure that the various aspects of the various aspects may be practiced in other examples that depart from these specific details. In certain instances, descriptions of well- known devices, circuits, and methods are omitted so as not to obscure the description of the various aspects with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), and/or digital signal processors (DSPs), that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations; or recording, storing, or transferring digital data. The term “processor circuitry” may refer an application processor; baseband processor; a central processing unit (CPU); a graphics processing unit; a single-core processor; a dual-core processor; a triple-core processor; a quad-core processor; or any other device capable of executing or otherwise operating computer-executable instructions, such as program code; software modules; or functional processes.

The term “interface circuitry” as used herein refers to, is part of, or includes circuitry that enables the exchange of information between two or more components or devices. The term “interface circuitry” may refer to one or more hardware interfaces; for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to computer, storage, or network resources provided by physical hardware element(s). A “virtualized resource” may refer to computer, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

Current L4S technology relies on an explicit congestion notification (ECN) in an IP header to indicate queue buildup in intermediate routers or radio links. Upon ECN reception, congestion signals may be propagated back to a sender. The signals may be sent via a transmission control protocol (TCP) ECN-echo that trigger scalable congestion control algorithms. A TCP congestion window reduced (CWR) bit may be sent back to acknowledge to the receiver that the congestion-indication echoing was received. Similar signaling may be supported on other layer 4 (L4) protocols such as QUIC.

When congestion is detected, the application server or application may adjust the application bit rate to meet capacity of the established communication link. As a result, L4S may deliver a seamless user experience even with variable traffic load and radio conditions.

Changing the ECN bits in an IP header as a queue starts to grow to signal congestion may be referred to as marking. ECN/L4S use to least significant bits of a traffic class field in an IPv4 or IPv6 header to encode four different code points. In ECN, a congestion mark is equivalent to a packet drop. In L4S, the congestion mark serves as an indication instead of dropping the packet.

L4S allows relatively fine granular congestion control depending on the application (for example, with active queue management (AQM) and scalable TCP). L4S allows for improved queue utilization and better use of network resources. If applied to the radio, it may allow for better spectrum utilization. Routers or nodes using AQM may signal EC and immediately upon detecting high delay or high buffer status.

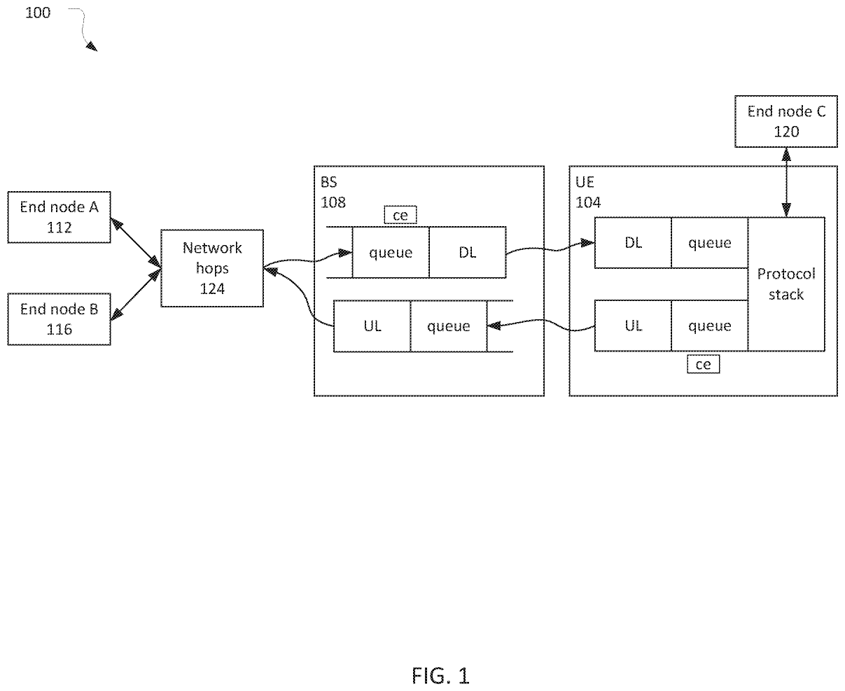

FIG. 1 illustrates a network environment 100 in accordance with some embodiments. The network environment 100 may include a UE 104 coupled with a base station (BS) 108 of a radio access network (RAN). In some embodiments, the base station 108 is a next-generation node B (gNB) that provides one or more 3GPP New Radio (NR) cells. In other embodiments, the base station 108 is an evolved node B (eNB) that provides one or more Long Term Evolution (LTE) cells. The air interface over which the UE 104 and base station 108 communicate may be compatible with 3GPP technical specifications, such as those that define Fifth Generation (5G) NR or later system standards.

The network environment 100 further includes three end nodes, end node A 112, end node B 116, and end node C 120. While shown separately in FIG. 1, end node C 120 may also be part of UE 104.

The end nodes may communicate with one another through the UE 104, RAN 108, and one or more network hops 124. The end nodes may host application layers that communicate application traffic with one another over the intervening network nodes. The network hops 124 may include hops in a RAN, core network (CN), external data network, etc.

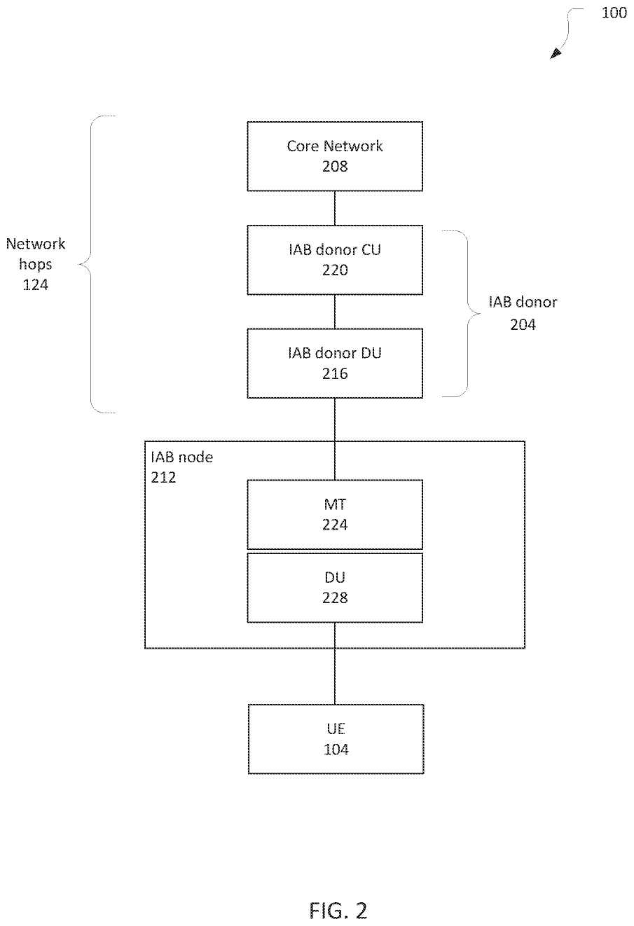

In some embodiments, the BS 108 or devices of the network hops 124 may include integrated access and backhaul (IAB) nodes that facilitate relaying of access traffic by sharing radio resources between access and backhaul links. FIG. 2 illustrates the network environment 100 implementing IAB concepts that may be used in some embodiments. In an IAB deployment, the network hops 124 may include an IAB donor 204 and core network 208. The IAB donor 204 may be a RAN node that provides an interface to the core network 208 and provides wireless backhauling functionality to an IAB node. An IAB node is a RAN node that provides the UE 104 with wireless access and wirelessly backhauls the access traffic to another IAB node or an IAB donor.

The base station 108 may correspond to a gNB or one or more of the IAB nodes (for example, IAB node 212, IAB donor 204, etc.). In some embodiments, the base station 108 may be separate from the IAB nodes and may be provided, for example, between IAB node 212 and the UE 104. The network hops 124 may include additional IAB nodes between IAB node 212 and the IAB donor 204.

The IAB donor 204 may have a distributed unit (DU) 216 and a centralized unit (CU) 220 disposed on separate devices. In general, the IAB donor CU 220 may handle higher-layer protocols, for example, radio resource control (RRC), packet data convergence (PDCP), and service data adaptation protocol (SDAP) layer protocols, while the IAB donor DU 216 may handle lower-layer protocols, for example, radio link control (RLC), media access control (MAC), and physical (PHY) layer protocols. In some embodiments, the base station 108 may provide CU and DU entities (for example, gNB-CU and gNB-DU).

The IAB node 212 may include a mobile termination (MT) 224 and a DU 228 that is coupled with the UE 104 or another IAB node. The MT 224 may be used to connect the IAB node 212 with an upstream (for example, towards the core network 208) RAN node (for example, IAB donor DU 216). In general, the MT 224 may provide the IAB node 212 with access functionality similar to a UE. For example, the MT 224 may utilize protocols that a typical UE may use to connect to a RAN. The MT 224 may, for example, allow the IAB node 212 to establish signaling radio bearers (SRBs) and/or data radio bearers (DRBs) with a parent node. The MT 224 may perform cell selection to identify an upstream RAN node to join and then set up and utilize an RLC channel through a backhaul adaptation (BAP) layer that provides functionality for routing data for different UE bearers over different routes through the network. The MT 224 may also perform, for example, cell reselection, radio-link failure, etc. In some embodiments, the IAB node to which the MT 224 connects, for example, the IAB donor 204, as shown, or another IAB node, may be considered the base station 108.

In a cellular data path architecture included within the network environment 100, queuing may apply to packets in the UE 104 and the BS 108. With respect to the UE 104, to ensure layer 2 (L2)/MAC has sufficient data available, new data from upper layers may constantly be added to the local queue. Based on anticipation of uplink grants from the BS 108, the data path may encipher and have new packets ready to be transmitted. However, due to the highly dynamic nature of wireless links in cellular networks such as 5G network at millimeter wave (mmWave) frequencies, it may be possible that throughput may drop for a sustained period of time. This may happen when the UE 104 has a non-line-of-sight (NLOS) connection with the frequency range 2 (FR2) tower. Additionally, due to sub-optimal radio conditions, the wireless link may experience retransmission of packets at several layers such as, for example, a MAC layer or a RLC layer. In such cases, the L2/MAC queues may experience buffer bloat. Similarly, with respect to the BS 108, packets may be queued up and waiting for scheduling opportunity and, based on the bandwidth conditions, the queues may experience buffer bloat. Embodiments of the present disclosure provide for detecting congestion at the queues of, for example, the UE 104 and BS 108. Upon detection of a congestion event, embodiments provide for setting a congestion experienced (CE) indication, which may be used to assist an application at one of the end nodes. The CE indication may be provided via ECN/L4S fields in an IP header and elsewhere as described herein.

5G NR and LTE support ECN at the IP layer where a base station and UE may insert ECN code points as specified in clause 5 of IETF request for comments (RFC) 3168, “The Addition of Explicit Congestion Notification (ECN) to IP,” September 2001. In particular, a UE and a base station may set a CE codepoint ‘11’ in a packet data convergence protocol (PDCP) service data unit (SDU) (in the IP packet). However, this means that ECN marking can only happen at the tail of the queue. Given that a UE's L2 buffer can be very large and grant-scheduling delays may exist, an ECN/L4S marking at an end of the queue may come with the disadvantage of additional delay for the CE endpoint reaching its destination. Embodiments described herein provide insertion of a CE codepoint at a head of the queue over MAC, for example, for transmission over an air interface.

The support of extended reality (XR) services require low latency and high throughput. L4S may be used to reduce latency and congestion and insured desired experience for users of XR services.

ECN/L4S is an end-to-end mechanism that depends on the capability of the transport network. It may enable faster codec rate adaptation at end points and may help to keep latency low and throughput high.

From a radio interface perspective, it may be advantageous to determine whether or not congestion exists at radio layers or other points within a 5G system. In some embodiments, congestion at an air interface may be indicated using one CE bit that is communicated to upper sublayers and translated into respective representation at an IP layer. However, to allow supportive use cases in which full end-to-end ECN/L4S consistency is desired, some embodiments may provide the CE indication with more than one bit (for example, two bits). ECN, L4S, and CE may be used interchangeably throughout this description.

Embodiments describe how a MAC layer can support an early CE indication mechanism to enable very fast indication at a lowest level of L2. Embodiments include methods for signaling CE codepoint for a MAC entity and MAC subheader and control element formats.

As mentioned earlier, 5G NR currently relies on ECN marking starting from the tail of the PDCP queue (i.e., from the head of the IP queue), which is slow considering the large size of the L2 buffer. One the other hand, XR services require lower latency and high throughput. To insert ECN/CE markings at the head of a normal PDCP DRB is rather difficult because PDCP performs ciphering and integrity protection. Hence, PDUs at the head of the PDCP queue cannot easily be modified by inserting ECN/CE marks directly.

Some embodiments provide for insertion of CE indication at the head of a logical channel (LCH) queue for a MAC entity to enable very fast feedback.

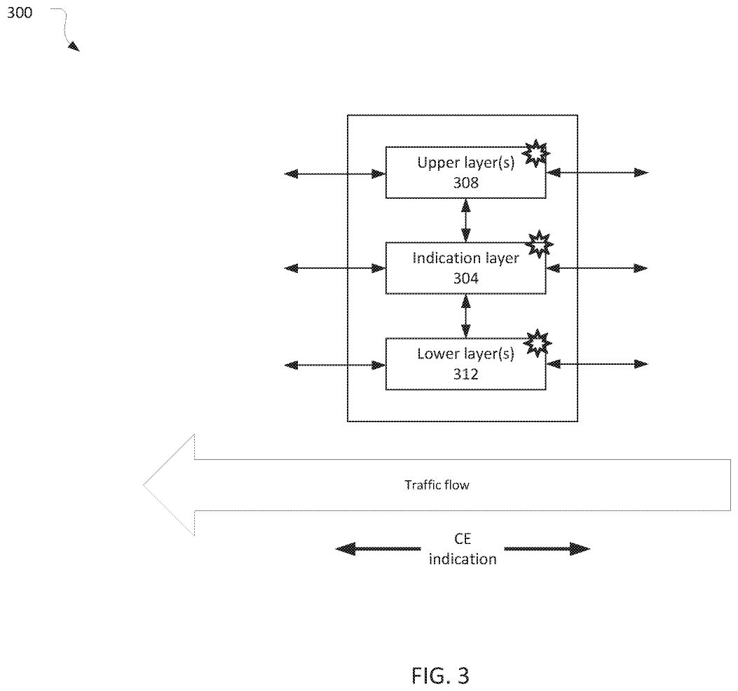

FIG. 3 shows a device 300 capable of providing a CE indication at a MAC layer in accordance with some embodiments. The device 300 may be the UE 104, base station 108 (as an IAB node or distinct therefrom), or a device of the network hops 124 (for example, an IAB node/donor). The device 300 may include a number of protocol layers, shown generically as indication layer 304, upper layer(s) 308, and lower layer(s) 312. The indication layer 304 may be a MAC layer that provides an indication of the congestion event. The upper layer(s) 308 and lower layer(s) 312 may be defined with respect to the indication layer 304

In various embodiments, the congestion event may be detected at the indication layer 304, the upper layer(s) 308, or the lower layer(s) 312. If the congestion event is detected in the upper layer(s) 308 or the lower layer(s) 312, the detection layer may inform the indication layer 304 with a congestion indication or event, for example, in a primitive, event, or message designed for inter-layer signaling.

Upon detecting the congestion event, either directly or from inter-layer signaling, the indication layer 304 may generate MAC packets that include CE indications, which may be referred to as CE packets. These CE packets may be transmitted from the indication layer 304 in the same direction as the traffic flow in which the congestion was detected, or in the opposite direction.

While embodiments describe the indication layer 304 providing CE indications in MAC packets transmitted in the uplink or downlink, it may be noted that the indication layer 304 may also inform upper layer(s) 308 or lower layer(s) 312 of the congestion. For example, if the indication layer 304 detects the congestion, or receives an indication of such from lower layer(s) 312, it may generate/send the CE packets and may also provide the upper layer(s) 308 with a congestion indication. For another example, if the indication layer 304 detects the congestion, or receives an indication of such from upper layer(s) 308, it may generate/send the CE packets and may also provide the lower layer(s) 312 with a congestion indication.

Some embodiments may include a buffer status report (BSR) based CE inference. A CE indication may be based on UE's (or IAB-MT's) reported buffer status in a BSR. This may be used in the uplink direction. The UE/IAB-MT reporting a buffer status that is higher than a first configured threshold (for example, threshold1) may be interpreted as an indication that the traffic is experiencing congestion. Thus, a certain buffer status level may be associated with congestion. The congestion may cease when a BSR is reported with a buffer status lower than a second configured threshold (for example, threshold2). Threshold1 can be different (e.g., typically higher) than threshold2. The congestion event determined based on the BSR may be associated with a logical channel group (LCG), LCH, or QoS flow.

In some embodiments, a MAC entity of a device may receive an indication of a congestion event from another layer of the device (as discussed above with respect to FIG. 3). In this instance, the MAC entity may provide a buffer size within a BSR in a manner to indicate the congestion event to another device. For example, if the event corresponds to a CE-set indication, the MAC entity may provide a BSR with an indication that the buffer size is greater than threshold 1 to provide the CE indication to the other device.

Upon detecting the congestion event at the receiver, the BS 108 may provide a congestion indication for the respective LCG, LCH or QoS flow to upper layers. The congestion indication may correspond to a CE-set indication to indicate congestion is present, or a CE-clear indication to indicate congestion is not present. The base station 108 may additionally/alternatively add a CE indication (or a flow control indication, which is already present in RAN3 interfaces) to a packet that is to be transmitted to the next node.

The last node (e.g., the CU or UPF) may translate the representation of the CE indication in the CE packet into a higher-layer CE indication and mark it for the respective IP packets. As will be described herein, a CE set/clear indication may not necessarily be sent for every packet.

In some embodiments, an explicit indication may additionally/alternatively be provided by a BSR. For example, one bit can be defined in a BSR to provide a CE indication (for example, a CE-set indication or a CE-clear indication) for a given LCG, LCH, or QoS flow

In some embodiments, the BSR can be given based on a QoS flow or an LCH granularity. For example, a BSR (and CE indication, as appropriate) may be provided for each QoS flow/LCH/LCG.

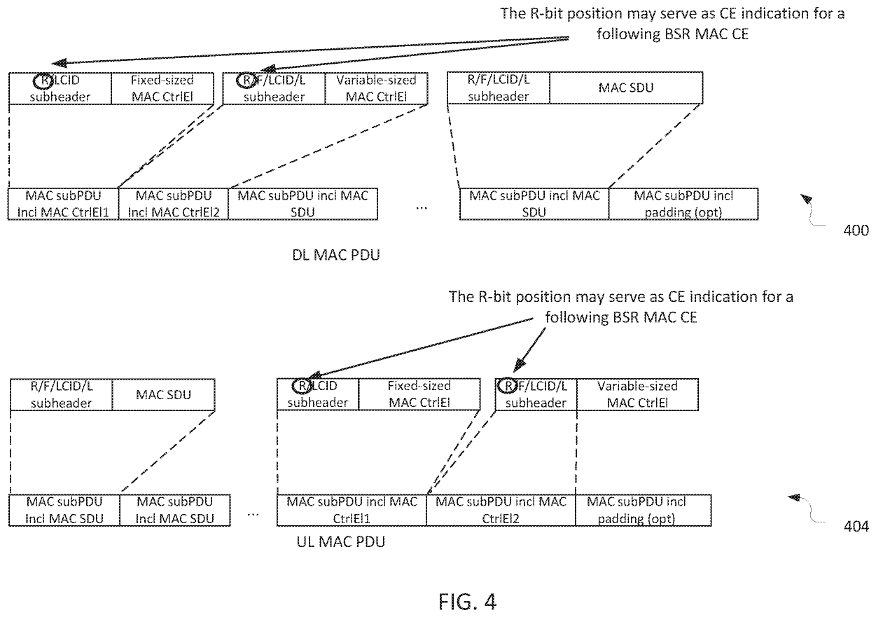

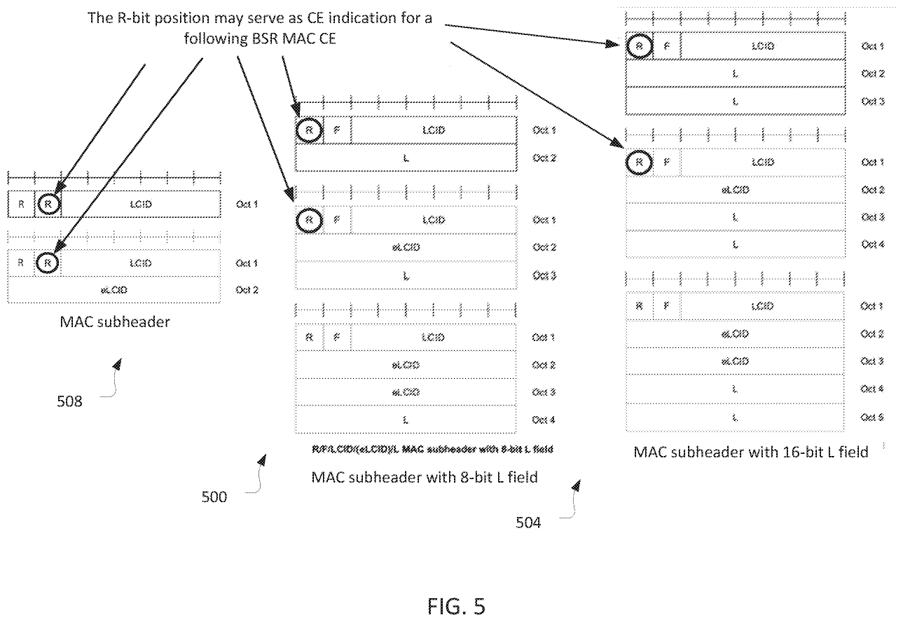

In some embodiments, a reserved bit in a MAC subheader may be used to indicate a congestion condition at the UE or IAB-MT side associated with a buffer status in BSR MAC control element (CtrlEl). With this option no additional CE bit may be needed in the BSR. FIGS. 4 and 5 illustrate examples of setting the reserved bit in a MAC subheader.

FIG. 4 illustrates MAC PDUs in accordance with some embodiments. In particular, FIG. 4 illustrates a downlink (DL) MAC PDU 400 and an uplink (UL) MAC PDU 404. The DL MAC PDU 400 may include an R/LCID subheader followed by a fixed-sized MAC CtrlEl, and an R/F/LCID/L subheader followed by a variable-sized MAC CtrlEl.

FIG. 5 illustrates MAC subheaders in accordance with some embodiments. In particular, FIG. 5 illustrates a first MAC subheaders 500 with an 8-bit L field, second MAC subheaders 504 with a 16-bit L field, and third MAC subheaders 508 without an L field. The first MAC subheaders 500 and the second MAC subheaders 504 may be referred to as R/F/LCID/(eLCID)/L MAC subheaders, while the third MAC subheaders 508 may be referred to as R/LCID/(eLCID) MAC subheaders.

The fields of the subheaders of FIGS. 4 and 5 may be defined as follows.

The R fields may be reserved bits, which may be used for CE indications as described below.

The L fields may be length fields used to indicate a length of a corresponding MAC SDU or variable-sized MAC CtrlEl in bytes.

The F fields may be format field used to indicate a size of the length field, with ‘0’ indicating an 8-bit length field and ‘1’ indicating a 16-bit length field.

The CE indication for BSR may be provided by the reserved bits in the MAC subheader. When used for the CE indication, the reserved bits may be referred to as CE bits. If the CE bit is set in a MAC subheader preceding a BSR, then that BSR contains a congestion indication for the LCG/LCH/QOS flow. The CE bit may need to be set for every BSR for as long as the congestion condition persists. No threshold configuration may be needed.

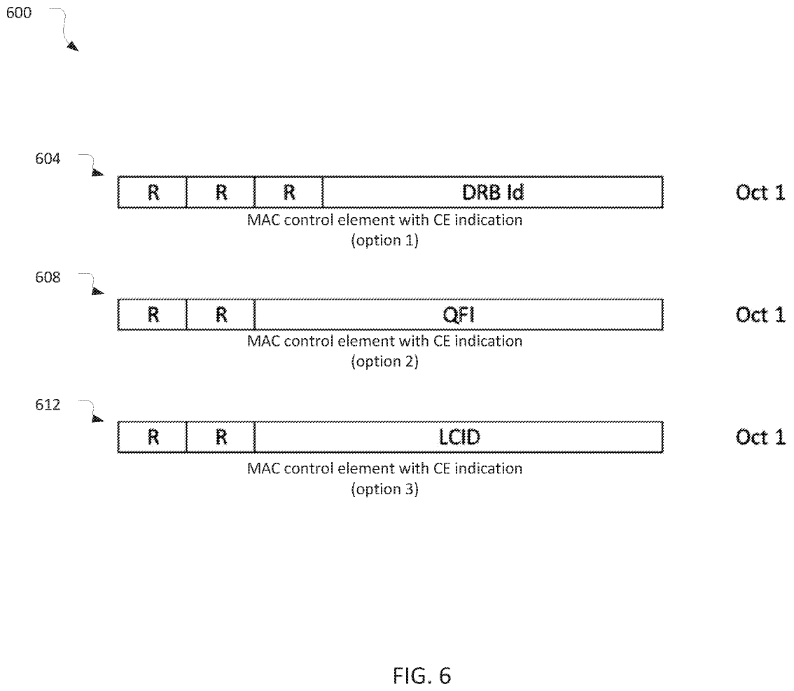

In some embodiments, a separate MAC CtrlEl can be defined for providing a CE indication. FIG. 6 illustrates three options for MAC control elements. In particular, FIG. 6 includes a MAC control element 604 having three reserved bits and a DRB identifier; a MAC control element 608 having two reserved bits and a QoS flow indicator (QFI); and a MAC control element 612 having two reserved bits and an LCID. One or more of the reserved bits of the MAC control elements 604, 608, or 612 may be set to provide the CE indication. The MAC control elements can be used to transmit the CE indication in the uplink direction or the downlink direction.

In some embodiments, a first MAC control element with CE indication may be sent when congestion is detected. For example, the first MAC control element may include a CE-set indication to indicate the LCG/LCH/QOS flow is experiencing congestion. A second MAC control element with CE indication may be sent when congestion is no longer detected. For example, the second MAC control element may include a CE-clear indication to indicate the LCG/LCH/QoS flow is no longer experiencing congestion. In between the first and second MAC control elements (CE-set followed by CE-clear) the upper layers of the device that receives the MAC control elements may ensure that all user plane/IP packets carry the CE indication previously signaled in the first MAC control element.

Any of the three options of MAC control elements for CE indications of FIG. 6 may be used for CE indication in an uplink shared channel (UL-SCH) or a downlink shared channel (DL-SCH). A transmitter may insert a MAC control element with CE indication whenever a congestion event changes (for example, congestion is detected or cleared). The R-bit positions may be used to signal a one-bit CE indication (for example, set or clear) or a two-bit indication.

While many embodiments describe congestion as existing in a binary state, for example, either congestion is present or is not, other embodiments may provide for different levels of congestion being detected/signaled in similar matters.

In some embodiments, two-bit CE indication may correspond to codepoints according to ECN codepoints shown in Table 1 or L4S codepoints shown in Table 2 below.

TABLE 1

| Binary codepoint | Codepoint name | Meaning |
|---|---|---|
| 00 | Not-ECT | Not ECN-capable transport |
| 01 | ECT(1) | ECN-capable transport |
| 10 | ECT(0) | ECN-capable transport |
| 11 | CE | Congestion experienced |

TABLE 2

| Binary codepoint | Codepoint name | Meaning |
|---|---|---|
| 00 | Not-ECT | Not ECN-capable transport |
| 01 | ECT(1) | L4S-capable transport |
| 10 | ECT(0) | Not L4S capable transport |
| 11 | CE | Congestion experienced |

These codepoints may be similar to those described in IETF RFC 3168.

In some embodiments, a MAC control element may be optionally extended to include an RLC or PDCP sequence number to which the congestion feedback applies.

Some embodiments may include a fourth option that represents a combined option that uses one or more of the options 1-3 of FIG. 6. With the fourth option, CE indications from a plurality of DRBs, QFIs, or LCIDs may be included in a single MAC control element. The single MAC control element may have a variable-sized format.

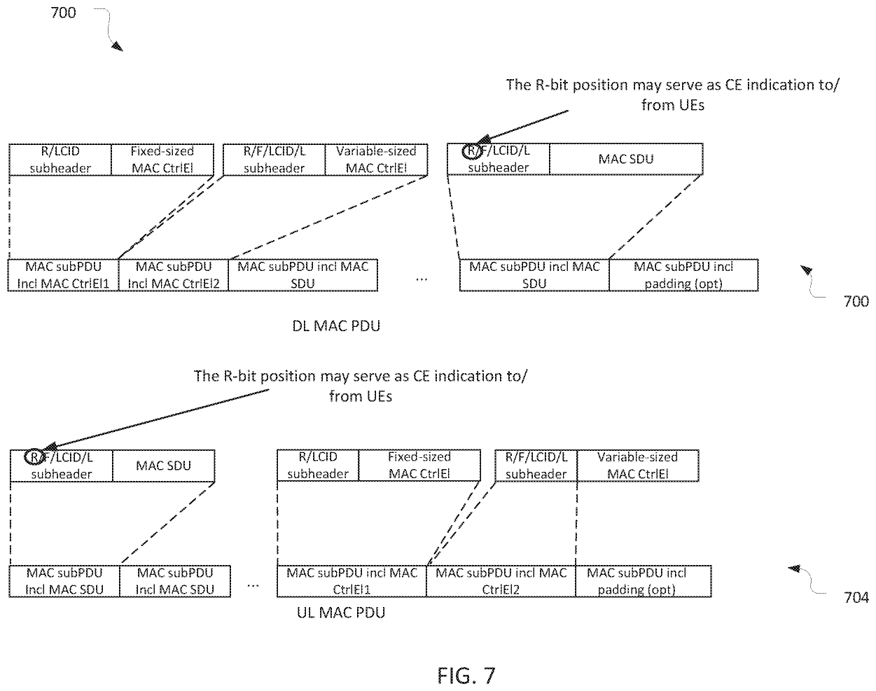

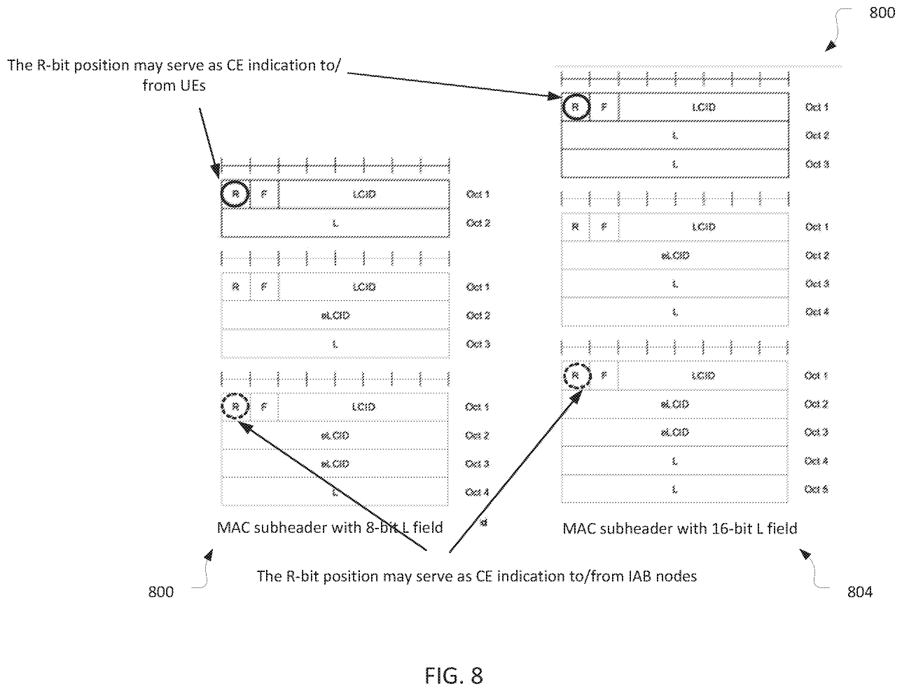

Some embodiments describe CE signaling for MAC SDUs such as that described by FIGS. 7 and 8.

FIG. 7 illustrates MAC PDUs in accordance with some embodiments. In particular, FIG. 7 illustrates a DL MAC PDU 700 and a UL MAC PDU 704. The DL MAC PDU 700 may include an R/LCID subheader followed by a MAC SDU. The UL MAC PDU 704 may include an R/F/LCID/L subheader followed by a MAC SDU

FIG. 8 illustrates MAC subheaders in accordance with some embodiments. In particular, FIG. 8 illustrates a first MAC subheader 800 with an 8-bit L field and a second MAC subheader 804 with a 16-bit field.

The CE indication may be signaled for individual MAC SDUs by using the R-bit positions in the MAC subheader preceding the MAC SDU as shown in FIG. 7. Upon detecting a congestion condition, the transmitter marks CE bits for the associated MAC SDU of the respective logical channel/LCID. The receiver extracts the congestion information and populates it to upper layers according to the LCID.

While marking the CE bits in the MAC subheader that precedes a MAC SDU is an effective way to provide the CE indication, it may require upper layers to populate the information through the stack (either by inserting it directly from upper layers or by populating it upwards/downwards from MAC to RLC to PDCP to IP and vice versa).

It may be noted that if RLC SDUs are segmented, the CE indication may be given for every segment and the upper layers may ensure to update the CE bits accordingly. This may provide increased reliability and faster signaling of a congestion condition, without waiting for any remaining segments.

In some embodiments, the CE indications for MAC SDUs may be used as flow control. In particular, the CE indications may be used to provide flow control between the UE 104 and the BS 108 at the MAC level.

Various network layer impacts may be considered in accordance with some embodiments.

Since MAC is supported only between UE (or IAB-MT) and gNB-DU, the IAB node or the gNB may need to extract the CE information from the MAC header and perform some operation with it. The operation may include delivering the CE information to upper layers; using flow control mechanisms (available on RAN3 interfaces) to signal the CE information; or forward the CE information to upper layers, which in turn forward the feedback indication further (e.g., at the gNB-CU).

Forwarding a CE indication may be performed in accordance with one or more of the following options. In a first option, the CE indication may be forwarded over a general packet radio service tunneling protocol (GTP) to the UPF, which then updates the IP header. In a second option, the BS 108 may update the IP header in the PDCP SDU. And, in a third option, the BS 108 may forward the CE indication to/from the IP layer. The ultimate destination of the CE indication may be an application layer in an end node. Thus, when the UPF receives the CE indication, it may forward the CE indication (or apply it) the/apply the L4S indications further.

A similar process may also apply in the opposite direction.

Advantages of MAC-based CE indications may include providing CE information at the finest granularity in terms of SNs, since very late updates (shortly before transmission of the transport block) are possible. Thus, CE indications become extremely fast. Some additional effort for populating CE information up and down the stack may be needed. Further, other network entities may require piggy-backing of CE information.

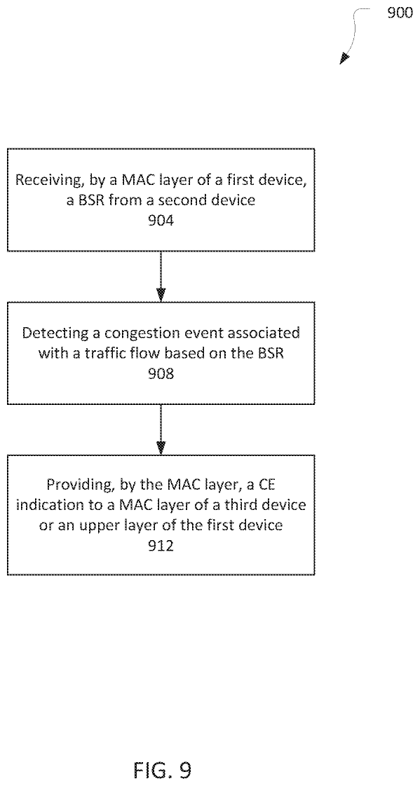

FIG. 9 is an operation flow/algorithmic structure 900 in accordance with some embodiments. The operation flow/algorithmic structure 900 may be implemented by a MAC entity in a first device. The first device may be a base station 108, an IAB node, or network node 1300 or components therein, for example, processing circuitry 1304.

The operation flow/algorithmic structure 900 may include, at 904, receiving, by a MAC layer of the first device, a BSR from a second device. The second device may be a UE or an IAB-MT that provides the BSR with an indication of a buffer level of the second device for a traffic flow. The traffic flow may correspond to an LCH, LCG, or QoS flow.

The operation flow/algorithmic structure 900 may further include, at 908, detecting a congestion event associated with a traffic flow based on the BSR. In some embodiments, the congestion event may be detected based on the buffer level indicated by the BSR. For example, if the buffer level is indicated greater than a first threshold, a congestion event corresponding to the traffic flow experiencing congestion may be detected. For another example, if the buffer level is indicated less than a second threshold, a congestion event corresponding to the traffic flow not experiencing congestion may be detected. In other embodiments, levels of congestion may be detected in similar matters.

In some embodiments, the congestion event may be detected based on explicit signaling. For example, one or two CE bits may be provided in the BSR or a subheader that is transmitted with the BSR to provide a CE indication.

The operation flow/algorithmic structure 900 may further include, at 912, providing, by the MAC layer, a CE indication to a third device or an upper layer of the first device. In some embodiments, the CE indication may be provided to a third device along with the traffic flow. For example, the first device may set CE bit(s) in a CE packet that is forwarded to the third device. The CE packets may be a MAC layer packet, for example, a MAC PDU, or a packet at another layer. The CE indication may additionally/alternatively be provided to upper layer(s) of the first device through an inter-layer signaling mechanism.

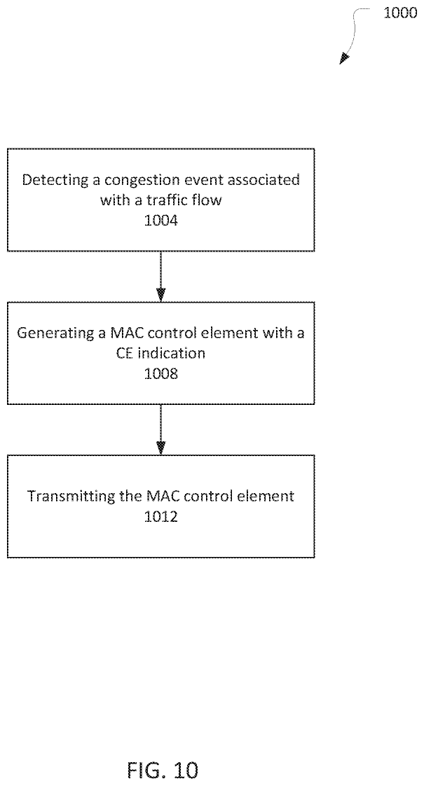

FIG. 10 is an operation flow/algorithmic structure 1000 in accordance with some embodiments. The operation flow/algorithmic structure 1000 may be implemented by a MAC entity in a UE (for example, UE 104 or UE 1200), the base station 108, an IAB node, or the network node 1300 or components therein, for example, processing circuitry 1204 or 1304.

The operation flow/algorithmic structure 1000 may include, at 1004, detecting a congestion event associated with a traffic flow. The traffic flow may correspond to an LCH, LCG, or QoS flow. In some embodiments, the congestion event may be detected directly by the MAC entity. For example, the MAC entity may determine a buffer level is greater than a first predetermined threshold or less than a second predetermined threshold. In other embodiments, the MAC entity may be signaled from a MAC entity of another device or another layer of the device implementing the MAC entity.

The operation flow/algorithmic structure 1000 may include, at 1004, generating a MAC control element with a CE indication. The MAC control element may include one octet that includes an identifier associated with the traffic flow. The identifier may be a DRB identifier, a QFI, or an LCID. The MAC control element may include one or two CE bits to provide the CE indication. In some embodiments, the MAC control element may include

The operation flow/algorithmic structure 1000 may further include, at 1008, transmitting the MAC control element.

In some embodiments, the upper layers may ensure that user plane/IP packets carry a CE indication that reflect correspond to the CE indication transmitted in the MAC control element. For example, if the MAC control element includes a CE-set indication, the user plane/IP packets may also include a CE-set indication until another MAC control element with a CE-clear indication is sent.

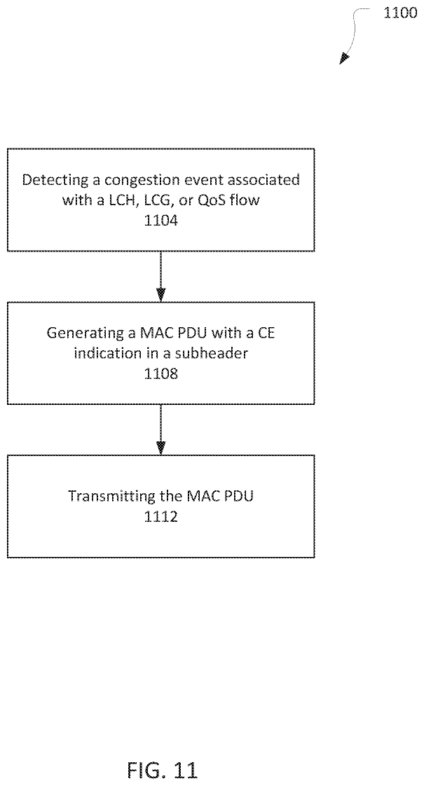

FIG. 11 is an operation flow/algorithmic structure 1100 in accordance with some embodiments. The operation flow/algorithmic structure 1100 may be implemented by a MAC entity in a UE (for example, UE 104 or UE 1200), the base station 108, an IAB node, or the network node 1300 or components therein, for example, processing circuitry 1204 or 1304.

The operation flow/algorithmic structure 1100 may include, at 1104, detecting a congestion event associated with an LCH, LCG, or QoS flow. In some embodiments, the congestion event may be detected directly by the MAC entity. For example, the MAC entity may determine a buffer level is greater than a first predetermined threshold or less than a second predetermined threshold. In other embodiments, the MAC entity may be signaled from a MAC entity of another device or another layer of the device implementing the MAC entity.

The operation flow/algorithmic structure 1100 may further include, at 1108, generating a MAC PDU with a CE indication in a subheader. The subheader may include one or more CE bits to provide the CE indication. The CE indication may be a CE-set indication or a CE-clear indication. In some embodiments, the subheader may be followed by a fixed-sized MAC control element, a variable-sized MAC control element, or a MAC SDU.

In some embodiments, the MAC entity may provide a congestion indication to one or more other layers of the device implementing the MAC entity based on the detected congestion event. These other layers may also provide CE indications in packets at respective layers or other congestion-related actions.

The operation flow/algorithmic structure 1100 may further include, at 1108, transmitting the MAC PDU. The MAC PDU may be transmitted in the same direction as the LCH, LCG, or QoS flow in which congestion was detected, or in an opposite direction.

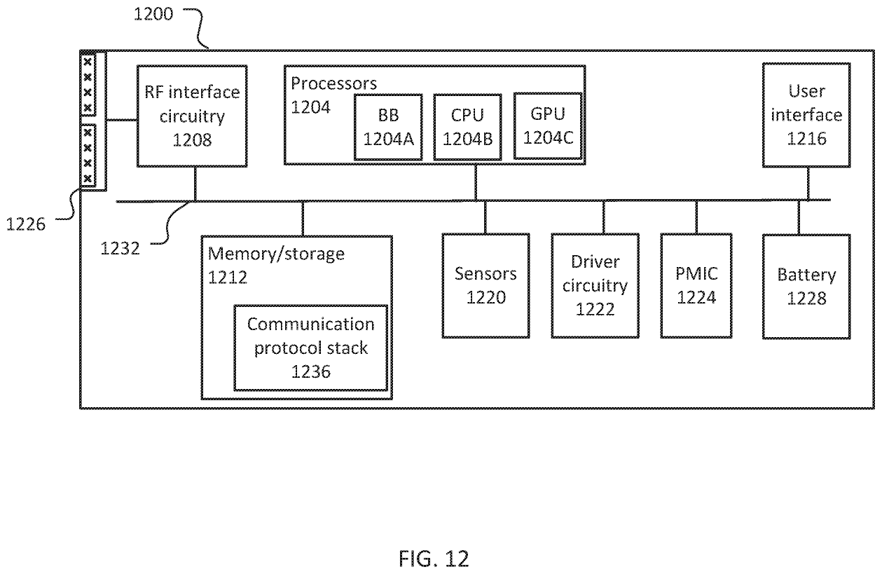

FIG. 12 illustrates a UE 1200 in accordance with some embodiments. The UE 1200 may be similar to and substantially interchangeable with UE 104 of FIG. 1.

The UE 1200 may be any mobile or non-mobile computing device, such as, for example, a mobile phone, computer, tablet, XR device, glasses, industrial wireless sensor (for example, microphone, carbon dioxide sensor, pressure sensor, humidity sensor, thermometer, motion sensor, accelerometer, laser scanner, fluid level sensor, inventory sensor, electric voltage/current meter, or actuator), video surveillance/monitoring device (for example, camera or video camera), wearable device (for example, a smart watch), or Internet-of-things device.

The UE 1200 may include processors 1204, RF interface circuitry 1208, memory/storage 1212, user interface 1216, sensors 1220, driver circuitry 1222, power management integrated circuit (PMIC) 1224, antenna structure 1226, and battery 1228. The components of the UE 1200 may be implemented as integrated circuits (ICs), portions thereof, discrete electronic devices, or other modules, logic, hardware, software, firmware, or a combination thereof. The block diagram of FIG. 12 is intended to show a high-level view of some of the components of the UE 1200. However, some of the components shown may be omitted, additional components may be present, and different arrangement of the components shown may occur in other implementations.

The components of the UE 1200 may be coupled with various other components over one or more interconnects 1232, which may represent any type of interface, input/output, bus (local, system, or expansion), transmission line, trace, or optical connection that allows various circuit components (on common or different chips or chipsets) to interact with one another.

The processors 1204 may include processor circuitry such as, for example, baseband processor circuitry (BB) 1204A, central processor unit circuitry (CPU) 1204B, and graphics processor unit circuitry (GPU) 1204C. The processors 1204 may include any type of circuitry or processor circuitry that executes or otherwise operates computer-executable instructions, such as program code, software modules, or functional processes from memory/storage 1212 to cause the UE 1200 to perform operations as described herein.

In some embodiments, the baseband processor circuitry 1204A may access a communication protocol stack 1236 in the memory/storage 1212 to communicate over a 3GPP compatible network. In general, the baseband processor circuitry 1204A may access the communication protocol stack 1236 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 1208.

The baseband processor circuitry 1204A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 1212 may include one or more non-transitory, computer-readable media that includes instructions (for example, communication protocol stack 1236) that may be executed by one or more of the processors 1204 to cause the UE 1200 to perform various operations described herein. The memory/storage 1212 include any type of volatile or non-volatile memory that may be distributed throughout the UE 1200. In some embodiments, some of the memory/storage 1212 may be located on the processors 1204 themselves (for example, L1 and L2 cache), while other memory/storage 1212 is external to the processors 1204 but accessible thereto via a memory interface. The memory/storage 1212 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1208 may include transceiver circuitry and radio frequency front module (RFEM) that allows the UE 1200 to communicate with other devices over a radio access network. The RF interface circuitry 1208 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 1226 and proceed to filter and amplify (with a low-noise amplifier) the signal. The signal may be provided to a receiver of the transceiver that down-converts the RF signal into a baseband signal that is provided to the baseband processor of the processors 1204.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1226.

In various embodiments, the RF interface circuitry 1208 may be configured to transmit/receive signals in a manner compatible with NR access technologies.

The antenna 1226 may include antenna elements to convert electrical signals into radio waves to travel through the air and to convert received radio waves into electrical signals. The antenna elements may be arranged into one or more antenna panels. The antenna 1226 may have antenna panels that are omnidirectional, directional, or a combination thereof to enable beamforming and multiple input, multiple output communications. The antenna 1226 may include microstrip antennas, printed antennas fabricated on the surface of one or more printed circuit boards, patch antennas, or phased array antennas. The antenna 1226 may have one or more panels designed for specific frequency bands including bands in FR1 or FR2.

The user interface circuitry 1216 includes various input/output (I/O) devices designed to enable user interaction with the UE 1200. The user interface 1216 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1200.

The sensors 1220 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters, image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1222 may include software and hardware elements that operate to control particular devices that are embedded in the UE 1200, attached to the UE 1200, or otherwise communicatively coupled with the UE 1200. The driver circuitry 1222 may include individual drivers allowing other components to interact with or control various I/O devices that may be present within, or connected to, the UE 1200. For example, the driver circuitry 1212 may include circuitry to facilitate coupling of a UICC (for example, UICC 128) to the UE 1200. For additional examples, driver circuitry 1222 may include a display driver to control and allow access to a display device, a touchscreen driver to control and allow access to a touchscreen interface, sensor drivers to obtain sensor readings of sensor circuitry 1220 and control and allow access to sensor circuitry 1220, drivers to obtain actuator positions of electro-mechanic components or control and allow access to the electro-mechanic components, a camera driver to control and allow access to an embedded image capture device, audio drivers to control and allow access to one or more audio devices.

The PMIC 1224 may manage power provided to various components of the UE 1200. In particular, with respect to the processors 1204, the PMIC 1224 may control power-source selection, voltage scaling, battery charging, or DC-to-DC conversion.

In some embodiments, the PMIC 1224 may control, or otherwise be part of, various power saving mechanisms of the UE 1200 including DRX as discussed herein.

A battery 1228 may power the UE 1200, although in some examples the UE 1200 may be mounted deployed in a fixed location, and may have a power supply coupled to an electrical grid. The battery 1228 may be a lithium ion battery, a metal-air battery, such as a zinc-air battery, an aluminum-air battery, a lithium-air battery, and the like. In some implementations, such as in vehicle-based applications, the battery 1228 may be a typical lead-acid automotive battery.

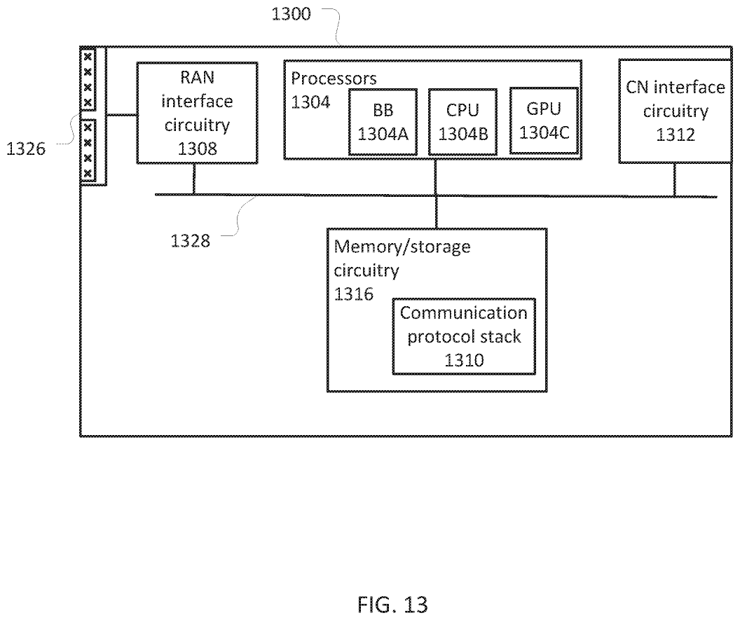

FIG. 13 illustrates a network node 1300 in accordance with some embodiments. The network node 1300 may be similar to and substantially interchangeable with base station 108, a device implementing one of the network hops 124, an IAB node, a network-controlled repeater, or a server in a core network or external data network.

The network node 1300 may include processors 1304, RF interface circuitry 1308 (if implemented as an access node), core network (CN) interface circuitry 1312, memory/storage circuitry 1316, and antenna structure 1326.

The components of the network node 1300 may be coupled with various other components over one or more interconnects 1328.

The processors 1304, RF interface circuitry 1308, memory/storage circuitry 1316 (including communication protocol stack 1310), antenna structure 1326, and interconnects 1328 may be similar to like-named elements shown and described with respect to FIG. 12.

The CN interface circuitry 1312 may provide connectivity to a core network, for example, a 5th Generation Core network (5GC) using a 5GC-compatible network interface protocol such as carrier Ethernet protocols, or some other suitable protocol. Network connectivity may be provided to/from the network node 1300 via a fiber optic or wireless backhaul. The CN interface circuitry 1312 may include one or more dedicated processors or FPGAs to communicate using one or more of the aforementioned protocols. In some implementations, the CN interface circuitry 1312 may include multiple controllers to provide connectivity to other networks using the same or different protocols.

In some embodiments, the network node 1300 may be coupled with transmit receive points (TRPs) using the antenna structure 1326, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary aspects are provided.

Example 1 includes a method of operating a first device, the method comprising: receiving, by a media access control (MAC) layer of the first device, a buffer status report (BSR) from a second device; detecting a congestion event associated with a traffic flow based on the BSR; providing, by the MAC layer, congestion experienced (CE) indication to a MAC layer of a third device or an upper layer of the first device.

Example 2 includes the method of example 1 or some other example herein, wherein detecting the congestion event based on the BSR comprises: determining the BSR is greater than a predetermined threshold; or detecting one or more bits in the BSR or in a MAC subheader of a MAC protocol data unit (PDU) the carries the BSR, the one or more bits to provide an indication of the congestion event.

Example 3 includes the method of example 2 or some other example herein, wherein detecting the congestion event based on the BSR comprises determining the BSR is greater than the predetermined threshold, the predetermined threshold is a first predetermined threshold, the congestion event is a first congestion event that indicates the traffic flow is experiencing congestion, and the method further comprises: determining the BSR is less than a second predetermined threshold; and detecting a second congestion event based on said determining the BSR is less than the second predetermined threshold, wherein the second congestion event indicates the traffic flow is not experiencing congestion.

Example 4 includes the method of example 1 or some other example herein, wherein traffic flows associated with a logical channel, a logical channel group, or a quality of service flow.

Example 5 includes a method comprising: detecting a congestion event associated with a traffic flow; generating a media access control (MAC) control element with a congestion experienced (CE) indication based on said detecting the congestion event; and transmitting the MAC control element.

Example 6 includes the method of example 5 or some other example herein, wherein the congestion event is a first congestion event that indicates the traffic flow is experiencing congestion at a first point in time and the method further comprises: detecting a second congestion event that indicates the traffic flow is not experiencing congestion at a second point in time; and transmitting user plane or Internet protocol (IP) packets with a CE indication in a time period between the first point in time and the second point in time.

Example 7 includes the method of example 5 or some other example herein, wherein the MAC control element is a first MAC control element, the CE indication is a CE-set indication to indicate the traffic flow is experiencing congestion, and the method further comprises: generating a second MAC control element with a CE-clear indication to indicate the traffic flow is not experiencing congestion; and transmitting the second MAC control element.

Example 8 includes the method of example 5 or some other example herein, wherein the MAC control element is one octet.

Example 9 includes the method of example 8 or some other example herein, wherein the MAC control element includes a data radio bearer (DRB) identifier associated with the traffic flow, a quality of service flow indicator associated with the traffic flow, or a logical channel identifier associated with traffic flow.

Example 10 includes the method of example 5 or some other example herein, wherein the CE indication in the MAC control element is to indicate a congestion event associated with a plurality of traffic flows.

Example 11 includes a method comprising: detecting a congestion event associated with an LCH, LCG, or QoS flow; generating a media access control (MAC) protocol data unit (PDU) with a subheader, wherein the subheader includes one or more bits set to provide a congestion experienced (CE) indication based on said detecting the congestion event; and transmitting the MAC PDU.

Example 12 includes the method of example 11 or some other example herein, wherein the congestion event is a first congestion event that indicates the LCH, LCG, or QoS flow is experiencing congestion at a first point in time and the method further comprises: detecting a second congestion event that indicates the LCH, LCG, or QoS flow is not experiencing congestion at a second point in time; and transmitting a plurality of MAC PDUs having subheaders with the one or more bits set to provide the CE indication in a time period between the first point in time and the second point in time.

Example 13 includes the method of example 11 or some other example herein, further comprising: providing, by one or more layers above a MAC layer, upper layer CE indications in one or more packets based on said detecting the congestion event.

Example 14 may include the method of example 11 or some other example herein, wherein the CE indication is a CE-set indication to indicate congestion is experienced by the LCH, LCG, or QoS flow or is a CE-clear indication to indicate congestion is not experienced by the LCH, LCG, or QoS flow.

Example 15 includes the method of example 11 or some other example herein, further comprising: performing flow control based on detecting the congestion event.

Example 16 includes a method of operating a first device, the method comprising: receiving, at a media access control (MAC) layer, a MAC protocol data unit (PDU) with a congestion experienced (CE) indication, the MAC PDU associated with a traffic flow from or to a second device; providing a signal to an upper layer of the first device, a MAC layer of the second device, or a third device based on the CE indication.

Example 17 includes the method of example 16 or some other example herein, wherein the CE indication is a CE-set indication to indicate the traffic flow is experiencing congestion or is a CE-clear indication to indicate the traffic flow is not experiencing congestion.

Example 18 includes the method of example 16 or some other example herein, wherein the signal is a flow control signal to signal congestion.

Example 19 includes the method of example 16 or some other example herein, wherein the first device is a base station distributed unit, the second device is a user equipment or integrated access and backhaul-mobile termination, and the method further comprises: providing the signal to an upper layer of the first device; generating, by the upper layer, a packet that includes the CE indication; and transmitting the packet to a corresponding upper layer of a base station centralized unit.

Example 20 includes the method of example 19 or some other example herein, wherein the upper layer is an Internet protocol (IP) layer.

Example 21 includes the method of example 16 or some other example herein, wherein the first device is an integrated access and backhaul (IAB)-mobile termination (MT) and the method further comprises: providing the signal to an RLC layer of the third device, wherein the third device is an IAB distributed unit or another IAB-MT.

Another example may include one or more non-transitory computer-readable media comprising instructions to cause an electronic device, upon execution of the instructions by one or more processors of the electronic device, to perform one or more elements of a method described in or related to any of examples 1-21, or any other method or process described herein.

Another example may include an apparatus comprising logic, modules, or circuitry to perform one or more elements of a method described in or related to any of examples 1-21, or any other method or process described herein.

Another example may include a method, technique, or process as described in or related to any of examples 1-21, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-21, or portions thereof.

Another example include a signal as described in or related to any of examples 1-21, or portions or parts thereof.

Another example may include a datagram, information element, packet, frame, segment, PDU, or message as described in or related to any of examples 1-21, or portions or parts thereof, or otherwise described in the present disclosure.

Another example may include a signal encoded with data as described in or related to any of examples 1-21, or portions or parts thereof, or otherwise described in the present disclosure.

Another example may include a signal encoded with a datagram, IE, packet, frame, segment, PDU, or message as described in or related to any of examples 1-21, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-21, or portions thereof.

Another example may include a computer program comprising instructions, wherein execution of the program by a processing element is to cause the processing element to carry out the method, techniques, or process as described in or related to any of examples 1-21, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of aspects to the precise form disclosed. Modifications and variations are possible in light of the above teachings or may be acquired from practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

1.-22. (canceled)

23. A method comprising:
receiving, by a first media access control (MAC) layer, a buffer status report (BSR) from a first device;
detecting a congestion event associated with a traffic flow based on the BSR; and
providing, by the first MAC layer, a congestion experienced (CE) indication to a second MAC layer of a second device or to an upper layer.

24. The method of claim 23, wherein detecting the congestion event based on the BSR comprises:
determining the BSR indicates a buffer level greater than a predetermined threshold; or
detecting one or more bits in the BSR or in a MAC subheader of a MAC protocol data unit (PDU) that carries the BSR, the one or more bits to provide an indication of the congestion event.

25. The method of claim 24, wherein the BSR is a first BSR, detecting the congestion event based on the first BSR comprises determining the first BSR indicates a buffer level greater than the predetermined threshold, the predetermined threshold is a first predetermined threshold, the congestion event is a first congestion event that indicates the traffic flow is experiencing congestion, and the method further comprises:
receiving a second BSR that indicates the buffer level is less than a second predetermined threshold.

26. The method of claim 25, further comprising:
detecting a second congestion event based on the second BSR indicating the buffer level is less than the second predetermined threshold, wherein the second congestion event indicates the traffic flow is not experiencing congestion.

27. The method of claim 23, wherein traffic flow is associated with a logical channel, a logical channel group, or a quality of service flow.

28. One or more non-transitory, computer-readable media having instructions that, when executed, cause processor circuitry to:
detect a congestion event associated with a traffic flow;
generate a media access control (MAC) control element with a congestion experienced (CE) indication based on detection of the congestion event; and
output the MAC control element for transmission.

29. The one or more non-transitory, computer-readable media of claim 28, wherein the congestion event is a first congestion event that indicates the traffic flow is experiencing congestion at a first point in time and the instructions, when executed, further cause the processor circuitry to:
detect a second congestion event that indicates the traffic flow is not experiencing congestion at a second point in time.

30. The one or more non-transitory, computer-readable media of claim 29, wherein user plane or Internet protocol (IP) packets are transmitted with a CE indication in a time period between the first point in time and the second point in time.

31. The one or more non-transitory, computer-readable media of claim 28, wherein the MAC control element is a first MAC control element, the CE indication is a CE-set indication to indicate the traffic flow is experiencing congestion, and the instructions, when executed, further cause the processor circuitry to:
generate a second MAC control element with a CE-clear indication to indicate the traffic flow is not experiencing congestion; and
output the second MAC control element for transmission.

32. The one or more non-transitory, computer-readable media of claim 28, wherein the MAC control element is one octet.

33. The one or more non-transitory, computer-readable media of claim 32, wherein the MAC control element includes a data radio bearer (DRB) identifier associated with the traffic flow, or a quality of service flow indicator associated with the traffic flow.

34. The one or more non-transitory, computer-readable media of claim 32, wherein the MAC control element includes a logical channel identifier associated with the traffic flow or a logical channel group identifier associated with the traffic flow.

35. The one or more non-transitory, computer-readable media of claim 28, wherein the MAC control element includes one or more CE indications to indicate congestion events associated with a plurality of traffic flows.

36. An apparatus comprising:
processor circuitry to:
detect a congestion event associated with a logical channel (LCH), logical channel group (LCG), or quality of service (QOS) flow;
generate a media access control (MAC) protocol data unit (PDU) with a subheader, wherein the subheader includes one or more bits set to provide a congestion experienced (CE) indication based on said detecting the congestion event; and
output the MAC PDU for transmission; and
interface circuitry coupled with the processor circuitry to enable communication.

37. The apparatus of claim 36, wherein the subheader is followed by a fixed-sized MAC control element, a variable-sized MAC control element, or a MAC service data unit.

38. The apparatus of claim 36, wherein the congestion event is a first congestion event that indicates the LCH, LCG, or QoS flow is experiencing congestion at a first point in time and the processor circuitry is further to:
detect a second congestion event that indicates the LCH, LCG, or QoS flow is not experiencing congestion at a second point in time.

39. The apparatus of claim 38, wherein the processor circuitry is further to:
output a plurality of MAC PDUs having subheaders with the one or more bits set to provide the CE indication for transmission in a time period between the first point in time and the second point in time.

40. The apparatus of claim 36, wherein the processor circuitry is further to:
provide, by one or more layers above a MAC layer, upper layer CE indications in one or more packets based on detection of the congestion event.

41. The apparatus of claim 36, wherein the CE indication is a CE-set indication to indicate congestion is experienced by the LCH, LCG, or QoS flow or is a CE-clear indication to indicate congestion is not experienced by the LCH, LCG, or QoS flow.

42. The apparatus of claim 36, wherein the processor circuitry is further to:
perform flow control based on detection of the congestion event.
